(19) United States
(12) Patent Application Publication
(10) Pub. No.: US 2025/0076820 A1
(43) Pub. Date: Mar. 6, 2025

(54) MEASURING SUPPORT FOR A WATCH MOVEMENT

(71) Applicant: Omega SA, Biel/Bienne (CH)

(72) Inventors: José LEHMANN, Bevaix (CH); Cédric NICOLAS, Neuchatel (CH)

(73) Assignee: Omega SA, Biel/Bienne (CH)

(21) Appl. No.: 18/810,627

(22) Filed: Aug. 21, 2024

(30) Foreign Application Priority Data
Sep. 6, 2023 (EP) 23195662.4

(51) Int. Cl. G04D 1/06

(52) U.S. Cl. CPC G04D 1/063

(57) ABSTRACT

A measuring support for a watch movement, designed to constitute a radial support, in a radial direction, of a control member or of a support zone, which includes a watch head including a watch movement, or which includes a watch movement enclosed in a test cap, in a position of radial support under stress of the watch head or respectively of the cap on the measuring support, wherein the measuring support includes either a single contact point in the radial direction, or a pair of lateral contact points that are symmetrical with respect to the radial direction.

### TECHNICAL FIELD OF THE INVENTION

The invention concerns a measuring support for a watch movement, designed to constitute a radial support, in a radial direction, of a control member or of a support zone, which is comprised by a watch head comprising a watch movement, or which is comprised by a watch movement enclosed in a test cap, in a position of radial support under stress of said watch head or respectively of said cap on said measuring support.

The invention lies in the field of monitoring watch movements, in particular monitoring the rate and/or amplitude of mechanical movements.

### Technological Background

To monitor and measure the rate and/or amplitude of a watch movement, it is known to carry out acoustic monitoring, to capture the sound emitted by the escapement of a caliber (mounted in a cap or cased in a watch head) in order to measure the rate and amplitude of the movement.

There are many ways of measuring the sounds (vibrations) emitted by a movement or a watch. For example, a contact microphone, an overhead microphone, or an optical system such as a laser vibrometer are all possible.

An overhead microphone is too sensitive to ambient noise and even noise internal to the measuring device. In watch production, movements are often tested in batches of ten units: if ten movements are running at the same time, each microphone only needs to hear the movement to which it is dedicated, and not the movements immediately next to it.

Laser vibrometers are used in laboratories, but are far too expensive, complex and cumbersome for mass production applications. It is also highly sensitive to vibrations and environmental variations.

An optical solution using light emission, for example with an LED, and reflection signal analysis, is more suitable for integrating movements into cases for processing complete batch, but the return signal is very weak, practically imperceptible, and again difficult to isolate from ambient noise. What is more, this solution uses too much energy for a portable system such as a case holding movements and associated sensors.

A sensor consisting of a piezo element used as a contact microphone is generally used for such measurements. Piezo elements are available in different types and geometries. Piezo elements are typically available in bar or disc form. And single or bimorph types (two piezo elements on top of each other). Bimorph bars are, a priori, much more sensitive, but more complex to contact and, above all, much more expensive.

But even with a piezo sensor, while such monitoring is not difficult on a static bench, it is more tricky to carry out on a moving object, for example on a cap or on a watch head mounted in a case and manipulated by a robot or similar, or on a manufacturing or control line.

This is because a piezo element is a fragile element. Pressing the object whose sound you want to capture directly against it could damage it. Mechanical stress should be avoided wherever possible.

A mechanical element is therefore needed to act as an interface between the piezo element and the movement, and also to hold the piezo element in position in the measuring device.

It must also be possible to ensure that only the sound coming from the watch movement is measured by the piezo element, and so this sensor must be isolated as far as possible from external disturbances, notably acoustic disturbances from other movements being tested nearby.

### SUMMARY OF THE INVENTION

The aim of the invention is to provide a cost-effective solution to the problem of holding a piezo sensor for rate and/or amplitude monitoring, particularly installed in a case or other spatially mobile support, and a solution that achieves lower sensitivity to ambient noise than current systems.

To this end, the invention relates to a measuring support according to claim 1.

### BRIEF DESCRIPTION OF THE FIGURES

The aims, advantages and features of the invention will be better understood on reading the detailed description which follows, with reference to the attached drawings, in which:

FIG. 1 shows a schematic partial cross section of a measuring and test case, which contains, on the left-hand side of the figure, a cap fitted with a watch movement, in a monitoring position which is a position in which this cap rests under stress on a measuring support according to the invention according to a first variant, and, on the right-hand side of the figure, a watch head also in a monitoring position, with the same measuring support according to the first variant;

FIG. 2 shows the measuring and test case from FIG. 1 in a cross section perpendicular to that of FIG. 1, showing watch heads on the left-hand side of the figure and caps on the right-hand side of the figure;

FIG. 3 shows a schematic partial perspective view of the measuring support according to the first variant;

FIG. 4 shows a schematic partial cross section, through an axis of a single contact point that it comprises, of the measuring support according to the first variant;

FIGS. 5 to 9 illustrate a measuring support according to a second variant, which has two lateral contact points:

FIG. 5 shows a schematic partial perspective view of the measuring support according to the second variant;

FIG. 6 shows a schematic partial top view of the measuring support according to the second variant;

FIG. 7 shows a schematic partial cross section, on a plane to which the two lateral contact points are symmetrical, of the measuring support according to the second variant;

FIG. 8 shows a schematic partial cross section, on a plane passing through the two lateral contact points, of the measuring support according to the second variant;

FIG. 9 shows a schematic partial cross section, similar to FIG. 1, of a watch head resting on a measuring support according to the second variant, with its two lateral contact points resting on its middle, in a plane parallel to the general plane of the watch head;

FIG. 10 shows a schematic partial cross section, similar to FIG. 1, of a cap containing a movement, the crown of which rests on a measuring support according to the second variant;

FIG. 11 shows a schematic partial cross section, similar to FIG. 9, of a watch head resting on a measuring support according to the second variant, with its two lateral contact points resting on its middle, in a plane perpendicular to the general plane of the watch head;

FIG. 12 shows the assembly shown in FIG. 11, in cross section on a plane perpendicular to that of FIG. 11;

FIG. 13 shows, analogously to FIG. 11, the case in which the watch head comprises a bezel, and in which the two lateral contact points ensure contact with the middle while avoiding any contact with the bezel;

FIG. 14 shows the assembly shown in FIG. 13, in cross section on a plane perpendicular to that of FIG. 13;

FIG. 15 is a detail of FIG. 10;

FIG. 16 is a detail of FIG. 9.

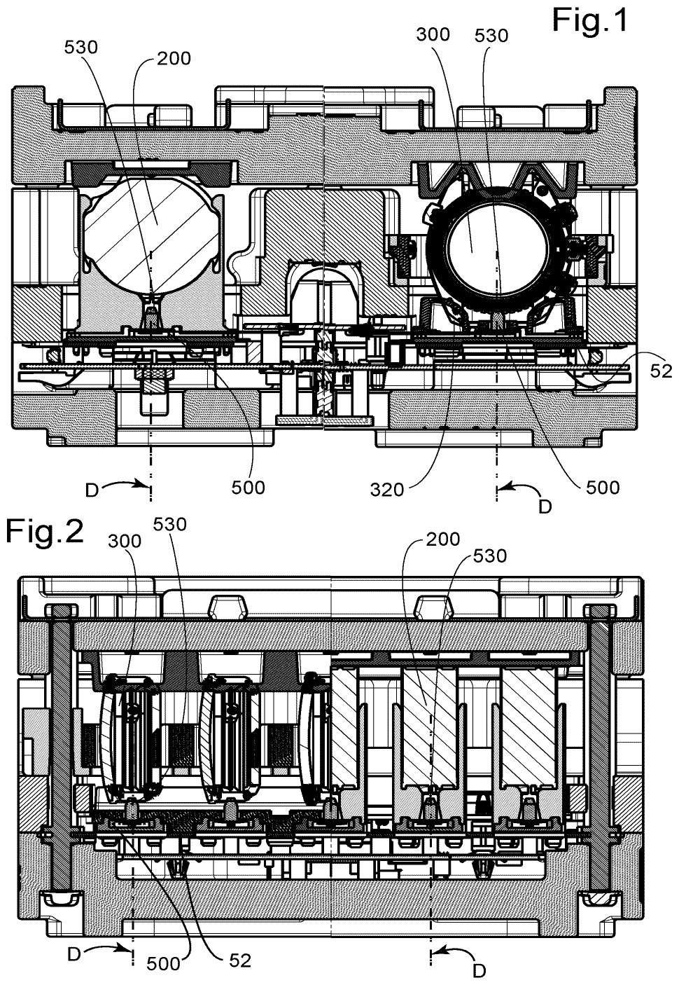

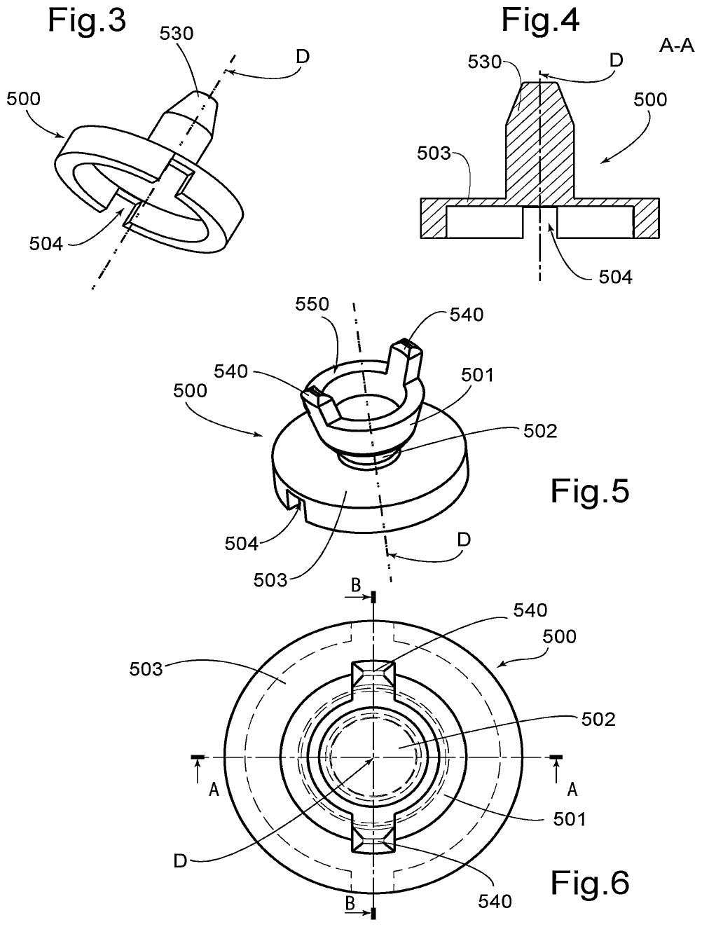

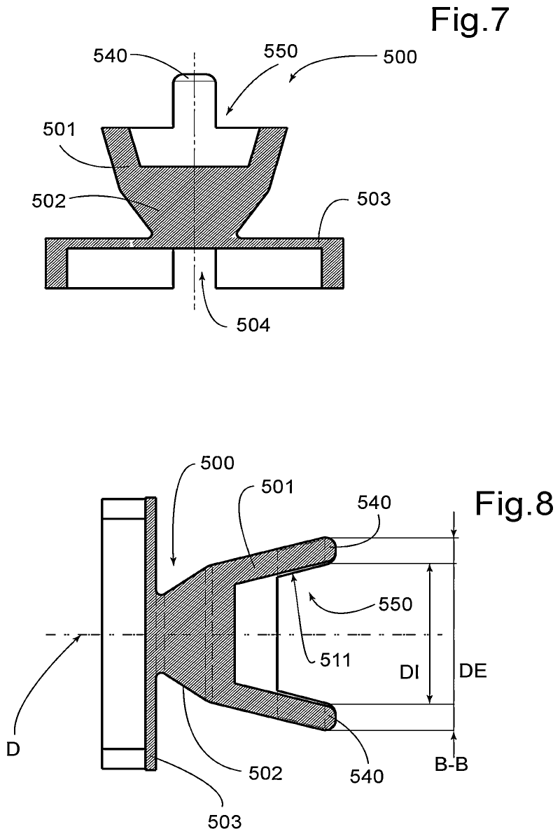

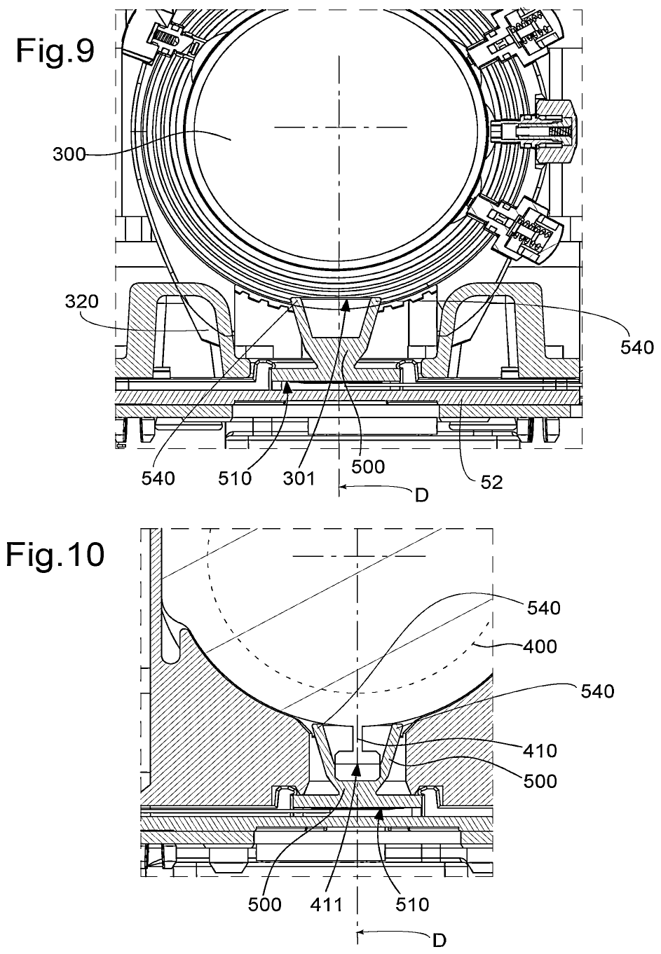

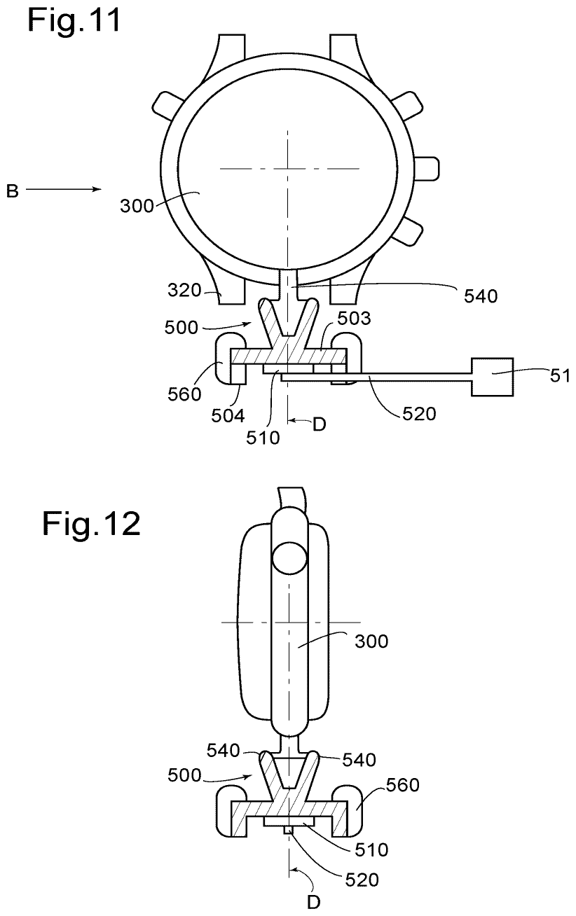

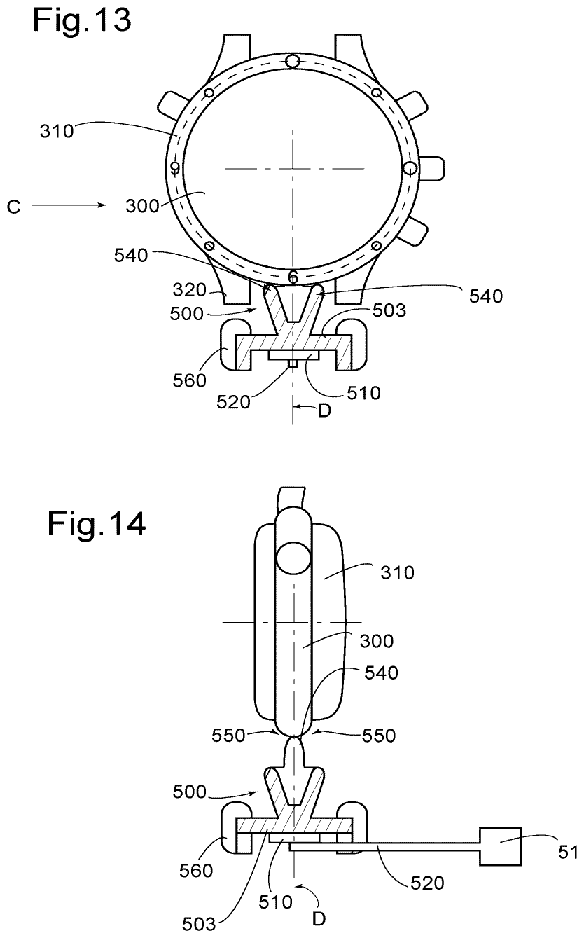

### DETAILED DESCRIPTION OF THE INVENTION

To provide an effective solution for protecting the sensor, the invention proposes fixing the sensor to a measuring support, which bears the mechanical force when bearing on the element to be monitored.

A simple piezo disk produced in large quantities and well known in the watchmaking industry (used as a buzzer) gives perfectly satisfactory results, so it can be used for an industrial application. In particular, the invention relates to the industrial configuration in which movements cased in caps or mounted in watch heads are stored in batches in transport cases on manufacturing or control lines. Such cases circulate in fairly long cycles, lasting several days or weeks, depending on the nature and frequency of the operations to be carried out, in particular for chronometric control operations; the aim is therefore to have inexpensive measuring supports, since they remain immobilized on these cases, and can withstand handling on conveyors, in stacker cranes, or other handling means.

Since sound is captured by contact, there are various options here too. The point of contact between the sensor and the object to be measured may vary.

Ideally, contact should be as direct and rigid as possible with the source generating the sound. In the case of a watch movement, the control stem is an appropriate element, and is the only valid element for cap-mounted movements. For movements cased in a watch head, it is also possible to obtain contact via the case, back or middle, for example. Contact with the glass is not always favorable, because the seals damp the vibration.

In the case of caps or watch heads grouped in batches of 10 in a processing case, sensors capable of measuring this or these tens of movements (in caps or cased) are required, with one sensor per movement, inserted in a case of given dimensions.

One difficulty is to be able to come into contact with as many types of watch as possible, whose geometry varies. The dimensions of the case require the watches to be positioned in line. There is no guarantee that the control stem is accessible, or even always in the same position. For cased movements, a check carried out at the horn width gives good results; moreover, this zone makes it possible to tolerate a small mark or local matting without detracting from the appearance of the watch case. It is therefore advantageous to arrange the sensor so that it makes contact with the middle at the horn width for watches, and with the control stem for cap-mounted movements.

If the watch head and cap are to be positioned in the same housings of a transport case, the contact zones with the sensor must be in two different positions.

The invention also concerns a measuring support 500 for a watch movement, which is designed to constitute a lower support for a cap 200 comprising a watch movement 400 or for a watch head 300 comprising a watch movement 400, in a position in which the cap 200 or the watch head 300 rests under stress on the measuring support 500. For example, this cap 200 or this watch head 300 is pushed towards the measuring support 500, and held in abutment on the measuring support 500 by compression means pushing this cap 200 or this watch head 300 on the side opposite to the side of abutment on the measuring support 500, in particular by at least one resilient element 80 which is in constrained abutment on this cap 200 or this watch head 300 on the side opposite to the side of abutment on the measuring support 500.

In this way, the measuring support 500 is designed to constitute a radial support, in a radial direction D, of a control member 410 or of a support zone 301, in particular an edge of a middle, which is comprised by a watch head 300 comprising a watch movement 400, or which is comprised by a watch movement 400 enclosed in a test cap 200, in a position of radial support under stress of this watch head 300 or respectively of this cap 200 on this measuring support 500.

According to the invention, the measuring support 500 comprises either, in a first variant, a single contact point 530 in the radial direction D, or, in a second variant, a pair of lateral contact points 540 that are symmetrical with respect to the radial direction D.

In the first embodiment, the measuring support 500 comprises such a single contact point 530 in the radial direction D, and comprises a printed circuit 52 extending on the opposite side to the single contact point 530, substantially perpendicular to the radial direction D, and the length of the single contact point 530, in the radial direction D, is greater than a minimum length which is calculated to prevent contact between horns 320 comprised by a watch head 300 and the printed circuit 52.

In particular, the single contact point 530 is rotationally symmetrical with respect to the axis D.

In the second variant, the measuring support 500 comprises a pair of lateral contact points 540 that are symmetrical with respect to the radial direction D.

In a particular embodiment of the invention according to this second variant, this measuring support 500 comprises a mouth 501, which includes the two lateral measuring points 540, and which is in the shape of an inverted bell, with a conical or evolving inner profile, the most flared side of which faces the cap 200 or watch head 300 to be monitored. This mouth 501 guides the vibrations towards a more massive concentrator part 502, integral with a base 503 under or on which is held a measuring sensor 510 designed to listen to the rate and/or amplitude of a watch movement 400 enclosed in a cap 200 or a watch head 300, in the position where this cap 200 or this watch head 300 rests under stress against this measuring support 500. And the pair of lateral contact points 540 is in the geometric extension of this mouth 501, or forms part of this mouth 501, which comprises, between the lateral contact points 540, indentations 550 which are designed to allow the contactless passage of a bezel 310 comprised by a watch head 300, or any other similar attachment.

More particularly, the inner part of the mouth 501 is rotationally symmetrical with respect to radial direction D and/or is substantially conical.

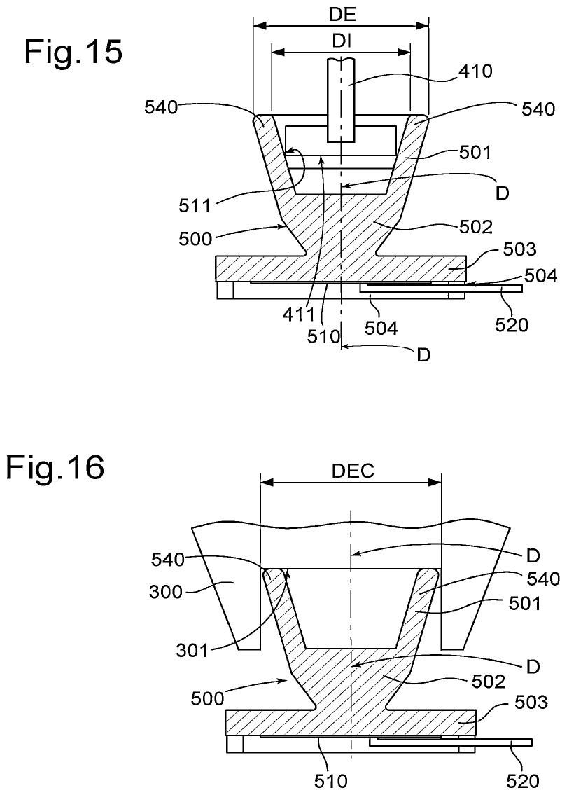

More specifically, as can be seen in FIG. 16, at its most open end, the mouth 501 has an external diameter DE smaller than the horn width DEC of the watch cases 300 to be measured, and, as can be seen in FIG. 15, an internal diameter DI greater than the diameter of the control members 410, in particular the crowns, of the movements 400 enclosed in the caps 200 to be measured, an internal bearing surface 511 of the mouth 501 or of the lateral contact points 540 being designed to receive these control members 410 in abutment. This complies well with space requirements, and makes the measuring support 500 extremely versatile.

More specifically, this measuring sensor 510 is a piezo sensor.

To ensure good sound transmission from the movement 400 to the piezo sensor 510, the number of interfaces must be kept to a minimum, and the best possible contact must be made at each interface. The connection between the piezo element and the measuring support must therefore be rigid, and this is easily achieved by gluing the piezo element over its entire surface in or on the measuring support 500, in particular with a rigid glue such as cyanoacrylate, for example. More specifically, this measuring sensor 510 is glued over its entire contact surface with the base 503 with a cyanoacrylate glue.

In particular, the measuring support 500 is made of hard material or metal. This is because a measuring support made of hard material ensures good transmission. In particular, tests show very good results with an aluminum alloy measuring support.

In particular, the measuring support 500 is made of aluminum alloy.

Alternatively, the measuring support 500 is made of bronze or cupro-aluminum.

Fixing the piezo sensor 510 to a rigid part such as the measuring support of the measuring support 500 has the effect of raising the resonant frequency of the entire sensor system (piezo element+measuring support) compared with that of the piezo element alone. This allows the resonant frequency to be shifted considerably outside the range of measured frequencies, to avoid chaotic behavior. In particular, the measuring support 500 is weighted with an inertial mass.

In particular, the mouth 501 is rotationally symmetrical with respect to the axis D.

FIG. 15 shows the contact between the distal end 411 of the control member 410 in the case of a cap 200, resting on an internal bearing surface 511 of the mouth 501 of the measuring support 500.

FIG. 16 shows the contact between a support zone 301, here for example between the horns of a watch head 300, and the end of the mouth 501 of the measuring support 500.

More particularly, the base 503 has at least one slot or groove 504 to receive a connecting cable 520 or similar connected to an electronic module or similar, for connecting the measuring sensor 510 to an electronic module 51, or two slots or grooves 504 that are symmetrical with respect to the axis D.

The base 503 is preferably the element for attaching to an external structure, in particular through a groove in a soleplate 560 made of flexible, resilient material, and wedged by a bead to hold it in place. More specifically, the base 503 is surrounded by a soleplate 560 made of flexible, resilient material, which is preferably removable, in particular by clip-fastening, and which comprises its only means of attachment to an external structure: the base 503, and therefore the measuring support 500, can be suspended while remaining in contact under stress with the cap 200 or the watch head 300.

The geometry of the measuring support constituting the mouth 501 must direct the sound towards the center of the piezo sensor 510. Point-contact at the center would probably be ideal. But realistically, the inverted cone shape is favorable. The way it works could be compared to a drum, where it is clear that the sound is much better and more powerful when the center of the membrane is hit rather than the edges.

The bell-shaped or inverted-cone geometry solves two problems:
by enabling contact to be established between the sensor 501 and watch heads 300 on the middle, or movements 400 in a cap 200 on stem 410, in the same footprint;
by improving the efficiency of sound pick-up, thanks to a shape that conducts and concentrates vibrations towards the center of the sensor.

In addition to the advantage of a quality measurement that is much more reliable than probing on a watch glass or case back, the particular measuring support implemented by the invention offers appreciable versatility, since it is suitable for both caps and watch heads; in the latter case, the support between horns is advantageous, and avoids affecting the visible surfaces of the watch head. In summary, the invention provides a cost-effective solution to the problem of holding a sensor, in particular a piezo sensor, for rate and/or amplitude control, and offers greater freedom from ambient noise pollution than current systems.

1. A measuring support for a watch movement, designed to constitute a radial support, in a radial direction, of a control member or of a support zone, which is comprised by a watch head comprising a watch movement, or which is comprised by a watch movement enclosed in a test cap, in a position of radial support under stress of said watch head or respectively of said cap on said measuring support, wherein said measuring support comprises either a single contact point in said radial direction, or a pair of lateral contact points that are symmetrical with respect to said radial direction.

2. The measuring support according to claim 1, wherein said measuring support comprises a said single contact point in said radial direction, and comprises a printed circuit extending on the opposite side to said single contact point, substantially perpendicular to said radial direction, and wherein the length of said single contact point, in said radial direction, is greater than a minimum length calculated to prevent contact between horns comprised by a said watch head and said printed circuit.

3. The measuring support according to claim 1, wherein said measuring support comprises a said pair of lateral contact points that are symmetrical with respect to said radial direction.

4. The measuring support according to claim 3, wherein said measuring support comprises an inverted bell-shaped mouth, the widest side of which is turned towards said cap or said watch head to be inspected, which mouth is designed to guide the vibrations towards a more massive concentrator part, integral with a base under which is held a measuring sensor designed to listen to the rate and/or amplitude of a said watch movement enclosed in said cap or said watch head, in the position where said measuring support rests under stress against said cap or said watch head, and wherein said pair of lateral contact points is in the geometric extension of said mouth, which comprises, between said lateral contact points, indentations designed to allow the contactless passage of a bezel which a said watch head comprises.

5. The measuring support according to claim 3, wherein the inner part of said mouth is rotationally symmetrical with respect to said radial direction or/and is substantially conical.

6. The measuring support according to claim 4, wherein said mouth has, at its most open side, at the distal end of said lateral contact points, an external diameter, smaller than the horn width of the watch cases to be measured, and an internal diameter greater than the diameter of said control members of movements enclosed in said caps to be measured, an inner support surface of said mouth or of said lateral contact points being designed to receive said control members in abutment.

7. The measuring support according to claim 1, wherein said control member is a crown.

8. The measuring support according to claim 1, wherein said support zone is an edge surface of a middle comprised by a said watch head.

9. The measuring support according to claim 1, wherein said measuring sensor is a piezo sensor.

10. The measuring support according to claim 1, wherein said measuring sensor is glued over its entire contact surface with said base with a cyanoacrylate glue.

11. The measuring support according to claim 1, wherein said base comprises at least one slot designed to receive a connecting cable for connecting said measuring sensor to an electronic module or a printed circuit.

12. The measuring support according to claim 1, wherein said measuring support is made of aluminum alloy.

13. The measuring support according to claim 1, wherein said measuring support is weighted with an inertial mass.

14. The measuring support according to claim 1, wherein said base is surrounded by a soleplate of flexible, resilient material comprising its sole means of attachment to an external structure.
